(19) United States
(12) Patent Application Publication
(10) Pub. No.: US 2023/0045664 A1
(43) Pub. Date: Feb. 9, 2023

(54) MILLING BLANK AND METHOD FOR THE PRODUCTION OF A DENTAL RESTORATION PART FROM A MILLING BLANK

(71) Applicant: Ivoclar Vivadent AG, Schaan (LI)

(72) Inventor: Goran Burger, Grabs (CH)

(21) Appl. No.: 17/817,907

(22) Filed: Aug. 5, 2022

(30) Foreign Application Priority Data
Aug. 9, 2021 (EP) 21190419.8

(51) Int. Cl. A61C 13/00; A61C 8/00; A61C 13/12

(52) U.S. Cl. CPC A61C 13/0022; A61C 8/005; A61C 13/0006; A61C 13/12

(57) ABSTRACT

A protective cap device for a milling blank, with a retaining element (24) or retaining extension (26) with which the milling blank (1) can be clamped, in particular in a clamping holder of a dental milling machine, and with a central channel (12) which extends over and/or passes through at least 70% of the length of the blank (1), is provided. The channel (12) terminates at or in the retaining element (24) or extension (26). A central pin (4) extends in the channel (12) and is either fixed or movably mounted in the channel (12), It is provided that a protective cap (10) covers an end face (20), which is opposite the retaining element (24) or retaining extension (26), of the milling blank (1).

### CROSS-REFERENCE TO RELATED APPLICATIONS

This application claims priority to European patent application No. 21190419.8 filed on Aug. 9, 2021, which disclosure is incorporated herein by reference in its entirety.

### TECHNICAL FIELD

The invention relates to a protective capping device for a milling blank, a milling blank, and a method for producing a dental restoration part from a milling blank.

### BACKGROUND

From WO 99/013 796 A1 a blank with an essentially rectangular cross-section is known. Fixing in a machining device is done on one side by means of a bolt-shaped adapter.

WO 2016/005 027 A1, WO 2015/044 862 A1 and corresponding U.S. Ser. No. 10/245,123, which US patent is incorporated by reference in its entirety, and WO 2016/062 375 A1 and corresponding U.S. Ser. No. 11/007,041B2 which US patent is incorporated by reference in its entirety, describe cylindrical and cylinder-like blanks that can be fixed on one side with a screw in a retaining element.

From EP 2 604 219 A1 and corresponding U.S. Pat. No. 8,820,726, which US patent is incorporated by reference in its entirety, and EP 2 837 357 A1 and corresponding US 2016193020, which US published application is incorporated by reference in its entirety, abutment retaining devices for a milling process are known, which have a fixing unit into which an abutment can be inserted. The blanks used are common cylindrical or cylinder-like (D-shaped in cross-section) dental blanks. One disadvantage of these known milling blanks is that they are not optimally oriented to the anatomical geometry of natural teeth and thus require unnecessary material, which can be avoided.

According to the known prior art, one-piece abutment blanks have become known, but their material and colour variety is limited and their compatibility with conventional retainer materials or devices is restricted. The conventional blanks exhibit either fewer or no anatomically oriented basic geometries, nor do they have multi-part system components.

### SUMMARY

It is therefore the object of the invention to provide a protective capping device for a milling blank, a milling blank, as well as a method for manufacturing a dental restoration part from a milling blank, which enables efficient manufacturing of individual, aesthetic and highly precise abutment and hybrid abutment restorations.

This object is achieved by the claims. Advantageous further embodiments result from the sub-claims.

According to the invention, a protective cap device for a milling blank is created to ensure the protection of the implant connection according to the invention.

The fixing of milling blanks in dental milling machines has so far mostly been implemented via the implant interface. The resulting stress on the sensitive implant interface is therefore unavoidable, so that the risk of deforming it is taken. This has an enormous influence on the accuracy of fit and service life of a dental restoration part. The design of the milling blank according to the invention with a retaining extension on the opposite side of the implant connection and a protection of the implant connection according to the invention makes it surprisingly easy to circumvent this problem.

According to the invention, the retaining extension is attached to the opposite end of the sensitive implant connection, via which the milling blank can be clamped, for example, in a clamping holder of a dental milling machine. The protective cap preferably serves to protect the implant connection from contamination, but can also be used for clamping. Clamping of the milling blank on both sides is also possible.

On the side of the implant connection, the milling blank has a truncated cone section so that the prefabricated basic geometry of the milling blank is optimally adapted to the natural shape of teeth. The use of anatomically oriented basic geometries means enormous material and thus cost savings as well as time savings.

The implant connection including the protective cap can be attached to this truncated cone section. When using multi-part system components, it is possible to reuse individual parts and thus to save on material and costs, which is also desirable in terms of protecting nature and the environment.

According to the invention, it is particularly advantageous to create a milling blank, which consists of ceramic, composite, metal or another dental material and is formed with a retaining extension.

The fixations of the respective blanks in the processing device depend significantly on the respective retaining element of the milling unit. The possibilities described here enable gentle clamping in conventional processing devices without placing excessive stress on the implant interface. The low mechanical stress on the implant interface allows a high precision during production and thus a high fitting accuracy as well as a longer service life of the dental restoration part.

One advantage of the solution according to the invention is the use of a partially manufactured milling blank, which has an advantageous effect on the efficient production of individual and aesthetic abutment and hybrid abutment restorations due to the design according to the invention. The use of a partially manufactured milling blank is advantageous because there is a smaller difference than with conventional blanks due to the geometric similarity between the blank and the finished milled product. This enables a faster and more efficient production of dental restoration parts and thus an enormous time and cost saving.

A partially manufactured milling blank is a blank for use in CAD/CAM milling operations. It is composed of single to multi-part elements which, in addition to the restoration material, have an abutment connection, reference surfaces and adapter components.

The restoration material is geometrically based on a natural tooth, so that the first rough milling step can be dispensed with during machining and less material has to be removed for finishing than with other blanks. The simplest way to achieve this is to design the restoration material in the shape of a truncated cone.

The milling blank has a truncated cone section at the part removed from the retaining extension, which extends over more than 30% of the length of the blank. This design not only saves an enormous amount of time, but also protects the milling cutter, as it has to remove less material, which greatly extends the life of the milling cutter and therefore saves costs. Expensive dental material can also be saved, as less material has to be removed and therefore less material is lost.

A variant of a partially manufactured milling blank according to the invention preferably consists of a dental material, such as metal or ceramic, and is preferably partially sintered. The base part of the restoration material, i.e. the truncated cone part, in the region of the connection geometry to the implant connection is, as already mentioned above, conical, i.e. truncated cone-shaped, in accordance with the invention, following the gingiva emergence profile. This has a surprisingly positive effect on the manufacturing process, as the conical shape imitates the natural shape of teeth right from the start and thus the machining time, the load and wear of the milling cutter as well as the loss of material during the milling process can be reduced enormously.

The milling blank has a central channel that extends over at least 70% of the length of the blank and/or passes through it. This channel ends at or in the retaining extension.

A central pin is inserted in the central channel of the blank, whereby the central pin is either fixed in the channel or is movably mounted. The central pin is sealed against the channel at the end on the retaining extension side and fills more than 50% of the channel when centred. Preferably, it fills the channel to more than 90% and optimally completely in order to achieve an optimal fixation and sealing against contamination by dust or swarf. If the central channel is not completely filled, the central pin can be easily inserted and positioned. This also allows an easy correction of the positioning of the milling blank without having to change the bore. Furthermore, such a design does not place high precision requirements on either the central pin or the bore of the central channel. This enables cost savings in manufacturing and thus also a cost-effective dental restoration part without having to accept a loss in quality.

When the central channel is completely filled, the central pin serves to stabilise the milling blank during the milling process. Such a central pin enables optimal fixation of the implant connection and distributes the forces acting on it uniformly over the entire blank up to the retaining extension, so that deformations are avoided and the resulting stress, which can lead to cracks in the dental material, is minimised.

In a further embodiment according to the invention, the central pin has a thread at the truncated cone end of the blank, which engages with a nut for fixation. In an advantageous embodiment, the nut is hexagonal. This nut in turn is covered by a protective cap to protect the nut and the central pin against the truncated cone. If a protective cap made of solid material, such as metal, is used, it can, on the one hand, serve as protection for important components against damage by the milling head during a milling process. The material of the protective cap is decisive here, as the milling head is harder than the components of the milling blank and a protective cap made of elastomer would not be able to counteract this. On the other hand, a protective cap equipped with a seal prevents the penetration of dust produced during the milling process or other impurities. The penetration of dust into sensitive parts such as the thread or into the central channel can cause unfavourable, irregular loads during the milling process, but also in the later use of the dental restoration part. Such contaminations are difficult to remove, can lead to wear over time and shorten the service life of a dental restoration part enormously.

In a further advantageous embodiment, the central channel has a thread, in particular at the end on the retaining extension side, at the end of the truncated cone or along the entire central channel. The central channel and the central pin, which in this embodiment has an external thread matching the thread of the central channel, can thus be screwed into each other. In addition, the protective cap can have a matching thread with which it can be screwed onto the central pin. This can serve on the one hand to fix the protective cap, but also to fix the central pin against being pulled out in the direction of the retaining extension side. The use of a threaded central pin also allows a simple fixing of the central pin before it is pulled out in the direction of the retaining extension side end by means of a nut which can be screwed onto the central pin at the truncated cone side or by means of a combination of all mentioned possibilities. In this respect, it is preferable that the thread is located opposite an implant connection.

In an advantageous embodiment, the central pin can also be protected from being pulled out by means of an increase in size on one end or side, a thickening on one end or side, a sealing lip or by means of screws. According to the invention, conventional adapter sections are attached to the truncated cone side of the partially manufactured milling blank. For this purpose, a recess can be made in the truncated cone side of the milling blank during the production of the milling blank, for example by a milling process, and the adapter part can then be glued in. Furthermore, it is conceivable that the adapter section be fixed to the truncated cone side of the partially manufactured milling blank by simple fixing with adhesive.

These adapter sections enable the compatibility of the partially manufactured milling blank according to the invention with common implant interfaces. The implant connection can be designed according to all common designs, such as a so-called external hex, an internal hex or a cone.

According to the invention, the adapter element of the blank is covered impermeably by a dome-shaped protective cap in order to prevent contamination of these parts, which are difficult to clean, by dust or swarf from the milling step. Furthermore, depending on the material of the protective cap, collisions of the milling tool with the implant connection can also be prevented. However, this is only the case if the protective cap is made of a very hard material, such as metal.

This protective cap can be attached to the implant connection in various ways. A simple frictional connection is one conceivable simple variant. However, other variants are also conceivable, such as designing of the sealing ring in such a way that it seals the protective cap against an undercut of the partially finished blank between the protective cap and the milling blank. In this case, a groove is provided in the partly finished milling blank on the truncated cone side, into which a protuberance or sealing lip of the protective cap provided for this purpose fits exactly. On the one hand, this seals the protective cap against the ingress of dust, and on the other hand, the interlocking of the sealing lip and the groove fixes the protective cap to the milling blank in a simple manner.

Furthermore, a thread can also be used to fasten the protective cap. For example, an external thread could be attached to the end of the central pin, which interacts with a matching internal thread attached to the protective cap. This variant is particularly conceivable with a solid protective cap made of solid rubber or similar materials. However, possibilities for hollow protective caps are also conceivable, in that, for example, the protective cap has a reinforcement with an internal thread at the lower end, through which the central pin, which has a suitable external thread, penetrates and thus fixes the protective cap, whereby the central pin, on the other hand, is protected from being pulled out by interacting with the protective cap itself. It is also possible to provide a nut which is otherwise surrounded by the material of the protective cap. The production of such a protective cap consisting of two materials is expediently carried out in such a way that the nut is overmoulded by plastic material of the protective cap. The relative dimensions are then preferably selected in such a way that the plastic material of the protective cap, when the nut is tightened under pretension, bears against the end face of the milled blank opposite the retaining element or retaining extension under pretension and seals particularly well there.

In an advantageous embodiment, the protective cap is hollow in order to enable the highest possible compatibility with various embodiments of the implant connection. For this purpose, a flexible plastic is preferably used, but other materials such as metals or ceramics are also possible.

In a further embodiment, the protective cap can also be made of a solid material, for example an elastomer, a brittle plastic or metal. In this case, the protective cap is at least partially connected internally to the central pin and/or the implant connection. The use of a brittle plastic would be a particularly cost-saving solution, since such plastics are cheap and easy to process, for example by means of a simple casting process.

It is particularly favourable if the implant connection is completely covered by the protective cap and the truncated cone end surface of the blank is covered by more than 50%, preferably completely, in order to effectively prevent the penetration of impurities.

In an advantageous embodiment, the protective cap is made of several parts, preferably two parts. The division along the longitudinal axis is particularly advantageous. An advantage of the two-part design is the simple assembly on the frustoconical end face and thus on the implant connection by simply placing the two halves together.

Furthermore, it is possible to make the transition between the protective cap and the central pin interlocking, so that the protective cap parts are fixed to the central pin at the same time. This interlocking can be achieved in various ways, for example by means of three-dimensionally extending prongs or by means of a thread. By means of this fixation, the protective cap is fixed on the one hand and the central pin is protected from being pulled out on the other hand.

In a preferred embodiment, the protective cap and the central pin are manufactured as one component and are made of plastic or metal, for example. This provides further improved stability.

A one-piece design of the central pin including the protective cap with seal, which seals against an undercut of the partially fabricated blank, enables an optimal seal between the protective cap and the restoration material against dust and contamination.

According to the invention, there is a sealing lip between the central pin and the protective cap at the bottom, i.e. at the end of the truncated cone, and between the central pin and the milling blank at the top, i.e. at the retaining extension side. This can be designed in various ways, for example as a seal against an undercut of the partially finished blank.

It is particularly advantageous if the restorative material of which the milling blank consists, at least for the most part, is composed of a ceramic, especially advantageously of lithium metasilicate. The volume change during the sintering process, which is carried out as a final step after the milling process, is optimally very small, so that the blank can be finish-sintered after milling without showing a significant volume change. Furthermore, other diverse dental materials such as metal, ceramic, composite, plastic and other polymer materials can be used as restorative materials. Titanium is preferred for a metallic design.

A multi-part design of the partially manufactured milling blank is particularly advantageous, which provides a composite material component or a mechanical fixation in order to fix the milling blank base body to a common retaining material. The holder or the part intended to be received in a clamping device may be varied in the different embodiments. For example, a simple adhesive fixation, a fixation via an attached retaining element or via a protruding retaining element that is part of the restorative material is possible.

According to the invention, such variations allow compatibility with various common interfaces, for example clamping or fixing mechanisms for milling blanks, of commercially available generating devices, in particular commercially available milling devices. This increases compatibility with common retaining devices of conventional systems.

The design of the partially fabricated milling blank or the geometry of the dental restoration part is fed into the software via CAD/CAM data and transferred to the dental milling machine by means of the control unit.

The scanning process of the patient situation is carried out with common intraoral and extraoral procedures. The CAD/CAM data set generated by this dental technology or dental process is compared with the stored basic geometries and tooth shades by means of a so-called data match, so that compatible variants of the partially finished milling blank can be selected to match the dental anatomical conditions. Furthermore, care must be taken to select the partially fabricated blanks with the matching retaining elements that are compatible for the respective milling device.

The blank data is assigned to the material, colour, dimension and interface by means of a barcode, RFID or 3D matrix code. The fabrication of implant-supported restorations starts after a comparison of the reference surfaces of the available partially fabricated blanks and the selection of the blank with the dimensions that have the best match with the implant to be fabricated.

Furthermore, the software has a CAD/CAM library of various embodiments of single-part or multi-part variants of partially fabricated milling blanks according to the invention. In addition, this library contains different tooth colours of the partially manufactured milling blanks based on a colour scheme as well as different basic geometries.

In an embodiment according to the invention, the milling blank is clamped in a clamping holder of a dental milling machine after being fitted with the central pin and the protective cap. The dental milling machine processes, in particular mills, the milling blank while the central pin extends in the channel and while the protective cap covers part of the end face of the truncated cone of the milling blank to prevent possible contamination with dust or chips.

To avoid contamination inside the protective cap, which is in particular hollow, a so-called sovereign zone is excluded from the milling process at the end of the truncated cone. This sovereign zone can be designed as a thin disc which remains on the truncated cone side of the partially finished milling blank during the milling process. This enables the protective cap to be securely anchored by sealing the gasket against an undercut of the partially finished blank, thus preventing the ingress of dust, chips or other contaminants during the milling process. Such a sovereign zone can be, for example, but not limited to, 0.2 mm thick.

In a preferred embodiment, the sovereign zone is conical, i.e. it increases from the outer edge of the milling blank to the centre, i.e. towards the dental component. This results in a flat cone, the underside of which is formed by the truncated side of the milling blank. This makes it possible to optimally distribute the forces arising during the milling process and thus avoid cracks in the dental material.

This sovereign zone can ultimately be removed during reworking or finishing milling. This can be done, for example, in the dental laboratory with a hand milling cutter.

The dental restoration part is milled from the milling blank in such a way that the gingival area of the milling blank is adjacent to the front surface of the truncated cone and the occlusal area is adjacent to the retaining extension.

The milling process starts from the gingival side of the milling blank, i.e. the end on the truncated cone side. During the milling process, retaining bars remain on the occlusal side, which connect the dental restoration to the retaining extension even after the milling step has been completed. In one embodiment of the invention, these are only removed together with the protective cap and the central pin after the milling step has been completed. Subsequently, the area of an implant connection can be finish-milled and the dental restoration part sintered in the final step.

According to an embodiment, a protective cap and milling blank assembly is provided comprising a milling blank and a protective cap, wherein the milling blank comprises a retaining element or a retaining extension with which the milling blank is configured for clamping in a clamping holder of a dental milling machine, a central channel which extends over at least 70% of the length of the blank and/or passes therethrough, wherein the channel ends at or in the retaining element or retaining extension, a central pin which extends in the channel, wherein the central pin is either fixed or movably mounted in the channel, and wherein the protective cap covers an end face, which lies opposite the retaining element or the retaining extension, of the milling blank.

It is preferred that the milling blank includes a truncated cone portion extending over more than 30% of the length of the blank at a part of the blank remote from the retaining element or retaining extension.

It is preferred that central pin includes a thread on the end face of the blank which engages with a nut and the protective cap (10) covers the nut. It is preferred that the protective cap is formed from an elastic material and covers an end face on the truncated cone side, of the blank. It is preferred that the elastic material is an elastomer and that the protective cap covers the end face on the truncated cone side by more than 50%. It is preferred that the protective cap is formed from solid material such as a plastic and/or metal, the protective cap bears at least partially against the central pin and/or an implant connection.

It is preferred that that a seal is provided between the central pin and the protective cap at the end face and/or between the central pin and the milling blank at the retaining extension side. It is preferred that the central pin is protected from being pulled out by a thickening at one end, a sealing lip or by screws.

According to a further embodiment, a method for producing a milling blank for milling a dental restoration part is provided comprising providing a blank, creating a central channel in the blank, which ends at or in a retaining element or retaining extension, at which the milling blank is configured for clamping in a milling machine, wherein more than 70% of a length of the blank is partially or fully penetrated with the central channel, introducing a central pin into the central channel, the central pin being fixed in the channel at an end having the retaining element or extension, and wherein the central pin and an end face which is opposite the retaining element or retaining extension are covered, by a protective cap which is attached in a sealing manner to the end face.

It is preferable that the central pin and the end face are covered by the protective cap to at least 50%.

It is preferable that the milling blank is partially manufactured and an implant connection extends on the end face, which is also covered by the protective cap.

It is preferable that the milling blank, after being equipped with the central pin and the protective cap, is clamped in a clamping holder of a dental milling machine and the dental milling machine mills the milling blank while the central pin extends in the channel and while the protective cap covers part of the end face of the milling blank.

### BRIEF DESCRIPTION OF THE DRAWINGS

Further advantages, details and features will be apparent from the following description of several embodiments of the invention with reference to the drawings.

FIG. 1A shows a schematic representation of the lateral cross-section of a partially fabricated milling blank according to the invention in a first embodiment.

FIG. 1B shows a schematic representation of the lateral cross-section of a further embodiment of a partially manufactured milling blank according to the invention.

FIG. 1C shows a schematic representation of the lateral cross-section of a further embodiment of a partially manufactured milling blank according to the invention.

FIG. 2 shows a schematic representation of the lateral cross-section of a further embodiment of a partially manufactured milling blank according to the invention.

FIG. 3 shows a schematic representation of the lateral cross-section of a further embodiment of a partially manufactured milling blank according to the invention.

FIG. 4 shows a schematic representation of the lateral cross-section of a further embodiment of a partially manufactured milling blank according to the invention.

FIG. 5 shows a schematic representation of the manufacturing process of a dental restoration part from a partially manufactured milling blank according to the invention.

FIG. 6 shows a schematic representation of the lateral cross-section of a further embodiment of a partially manufactured milling blank according to the invention.

FIG. 7 shows a schematic representation of the lateral cross-section of a further embodiment of a partially manufactured milling blank according to the invention.

FIG. 8 shows a schematic representation of the lateral cross-section of a further embodiment of a partially manufactured milling blank according to the invention after the milling process.

### DETAILED DESCRIPTION

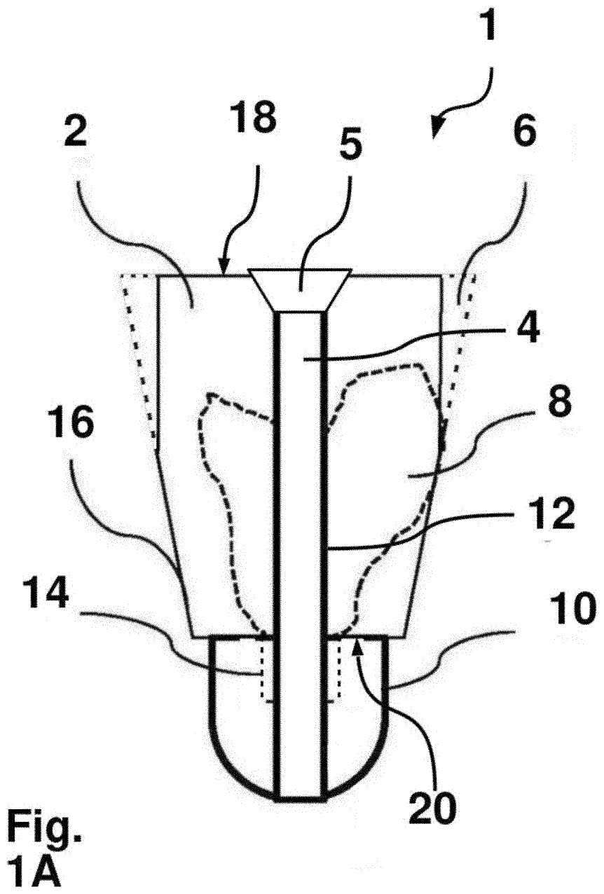

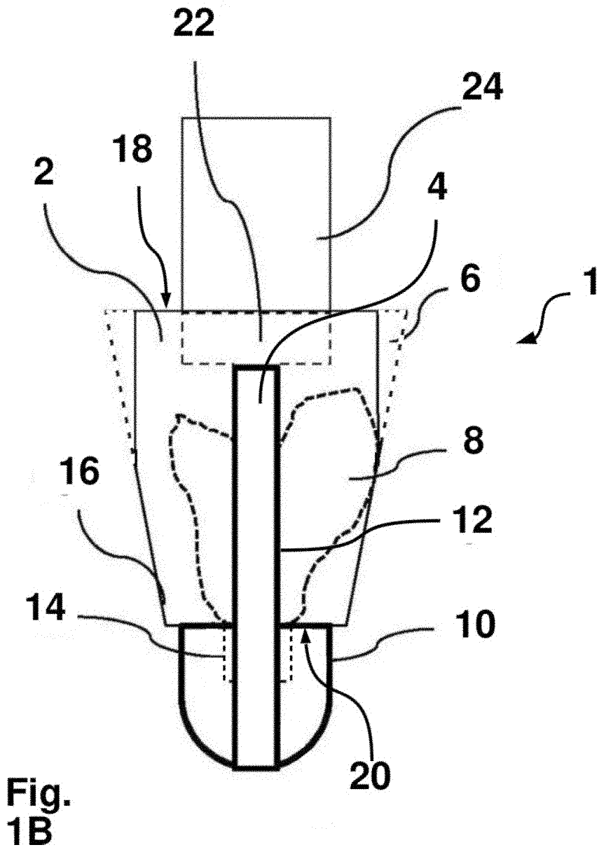

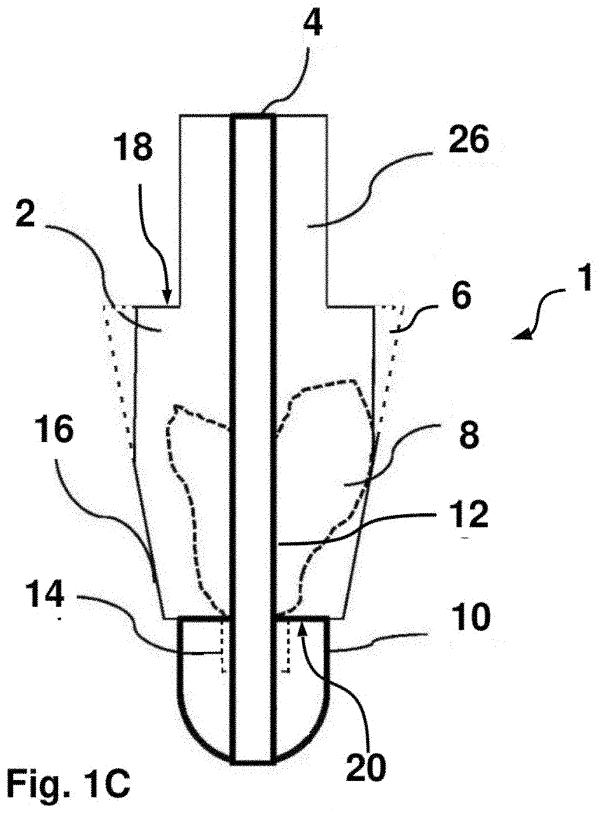

FIG. 1A shows a schematic representation of the lateral cross-section of a partially manufactured milling blank 1 according to the invention with central pin 4 and pin counter element 5, protective cap 10, schematically indicated implant-supported dental restoration part 8 and an external hex implant connection 14. This variant of the partially manufactured milling blank is a one-piece embodiment of a blank 1 according to the invention. The embodiment of an implant-supported dental restoration part 8 is shown schematically with dashed lines therein. In this embodiment, fixation to a common retaining material is provided by means of adhesive fixation. One could also say that the milling blank itself can thus serve as a retaining element. An embodiment of an implant-supported dental restoration part 8 created with CAD/CAM software is shown as a dashed tooth outline and connected to the external hex implant connection 14. In this embodiment, the central channel 12 passes through the entire length of the partially fabricated blank 1.

The base body 2 of the partially fabricated milling blank has a basic conical geometry, whereby the front side 18 has a larger diameter than the base 20 in order to adapt to the natural geometry of the occlusal and gingival tooth form areas. By removing the indicated excess areas 6 of the base body, the shape of a truncated cone 16 is formed. Of course, it is also possible to design and pre-sinter the shape of a truncated cone 16 already during the production of the blank, without the suggested excess areas 6. This special shape is close to the natural tooth geometry and thus avoids unnecessarily long milling processes. The dome-like protective cap 10 is attached to the truncated cone end or base 20 of the milling blank 1. In this embodiment, the central pin 4 fills the channel bore 12 with a snug fit. The pin counter element 5 serves to fix the central pin 4 to the retaining extension side end of the milling blank 1.

FIG. 1B shows a schematic representation of the lateral cross-section of a further embodiment of a partially manufactured milling blank 1 according to the invention with central pin 4, protective cap 10, schematically indicated implant-supported dental restoration part 8, an external hex implant connection 14 and a further embodiment of a retaining element 24, which is attached to or partially in the partially manufactured milling blank. This variant of the partially manufactured milling blank is a multi-part, in particular two-part, embodiment of a partially manufactured blank 1 according to the invention as shown in FIG. 1A. In this embodiment, a fixing to a common retaining material is provided by means of an attached retaining extension 26 or retaining element 24. This can be accommodated in the recess 22 provided for this purpose in the base body 2 of the partially finished milling blank. In this embodiment, the central channel 12 does not run through the entire length of the partially finished blank 1. It ends at the point at which the attached retaining element 24 is inserted into the recess 22 provided in the base body 2 of the partially finished milling blank.

FIG. 1C shows a schematic representation of the lateral cross-section of a further embodiment of a partially manufactured milling blank 1 according to the invention with central pin 4, protective cap 10, schematically indicated implant-supported dental restoration part 8, an external hex implant connection 14 and a retaining extension 26 as part of the basic body 2 of the partially manufactured milling blank. This variant of the partially manufactured milling blank is a one-piece version of a blank 1 according to the invention, like the one shown in FIG. 1A, but in a further embodiment. In this embodiment, fixing to a common retaining material is provided by means of an integrated retaining extension 26. This is part of the base body 2 of the partially manufactured milling blank. In this embodiment, the central channel 12 again runs through the entire length of the partially finished blank 1.

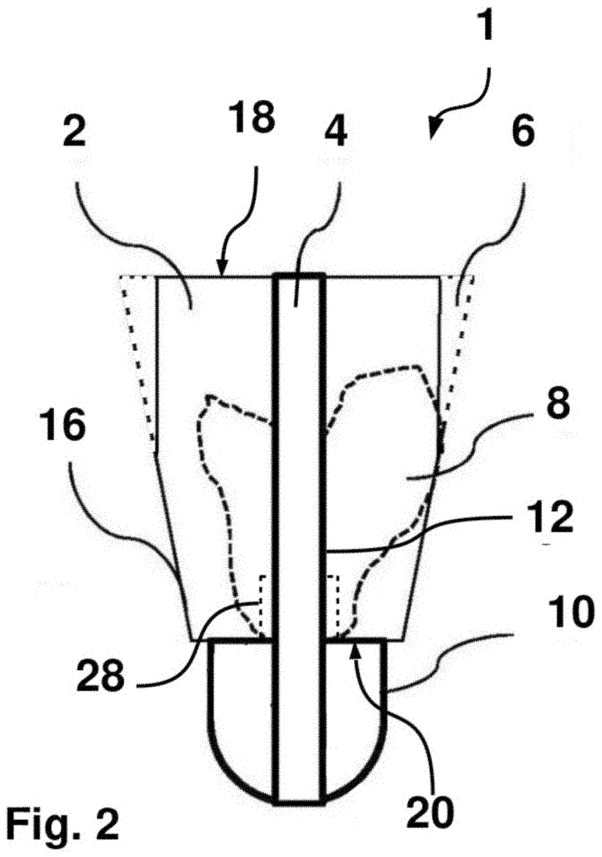

FIG. 2 shows a schematic representation of the lateral cross-section of a further embodiment of a partially manufactured milling blank 1 according to the invention with central pin 4, protective cap 10, schematically indicated implant-supported dental restoration part 8 according to FIG. 1A, but with an internal hex implant connection 28.

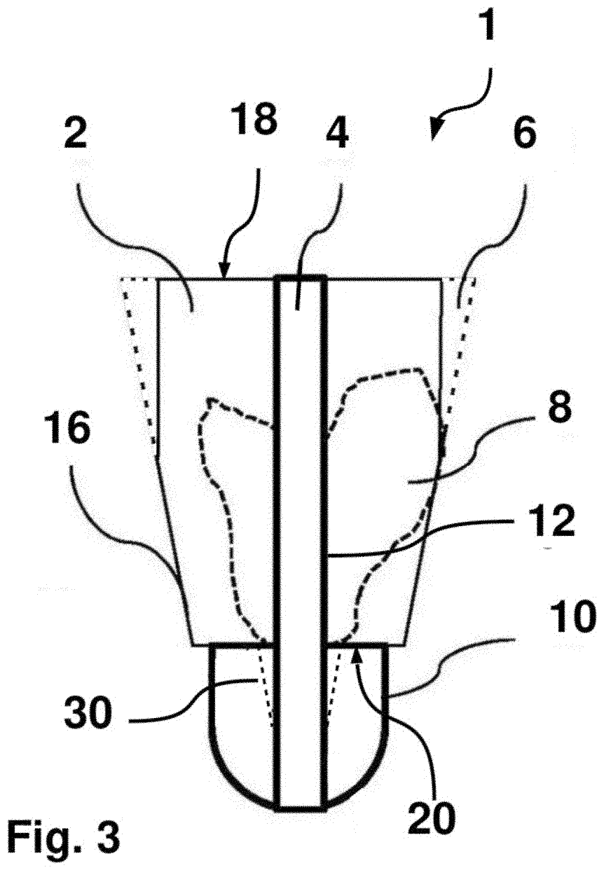

FIG. 3 shows a schematic representation of the lateral cross-section of a further embodiment of a partially manufactured milling blank 1 according to the invention with central pin 4, protective cap 10, schematically indicated implant-supported dental restoration part 8 according to FIG. 1A, but with a conical implant connection 30.

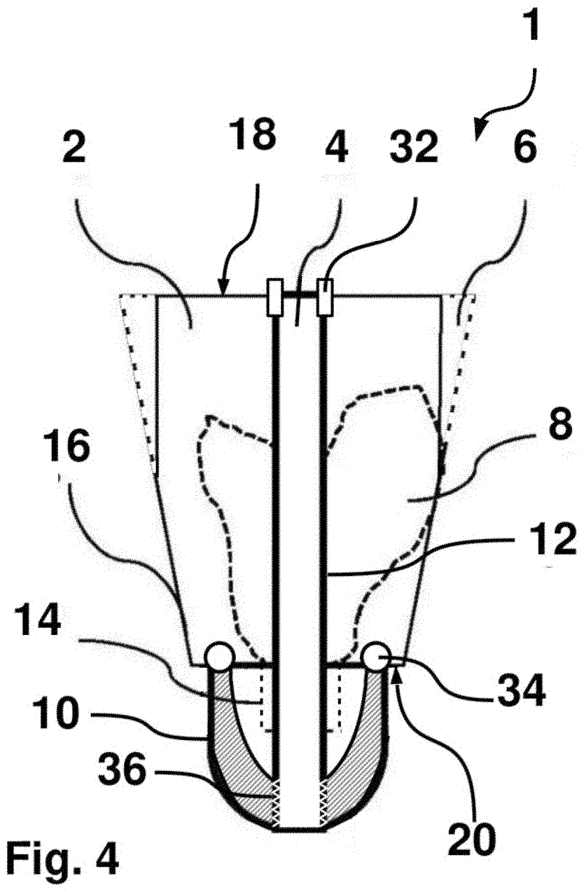

FIG. 4 shows a schematic representation of the lateral cross-section of a further embodiment of a partially manufactured milling blank 1 according to the invention with central pin 4, protective cap 10 with threaded fixing 36, schematically indicated implant-supported dental restoration part 8 and an external hex implant connection 14. In this embodiment, a sealing lip 32 is inserted between the central pin 4 and the central channel 12 at the retaining extension side end, which seals the central channel 12 against contamination with dust or chips that occur during the milling process. In this embodiment, the central channel 12 passes through the entire length of the partly finished blank 1. Furthermore, an external thread is formed at the end on the truncated cone side or at the base 20 of the central pin 4, which is formed to match the thread 36 of the protective cap 10, so that these two threads can be screwed into one another. On the one hand, this allows the protective cap 10 to be fixed and, on the other hand, it prevents the central pin 4 from being pulled out in the direction of the retaining extension/face 18. In this embodiment, the protective cap 10 is hollow but thick-walled and is sealed to the base body 2 of the partially manufactured milling blank by means of a design 34 in such a way that it seals the protective cap against an undercut of the partially manufactured blank. This design 34 enables the protective cap 10 to be fastened to the base body 2 of the partially finished milling blank and ensures optimum sealing against possible impurities.

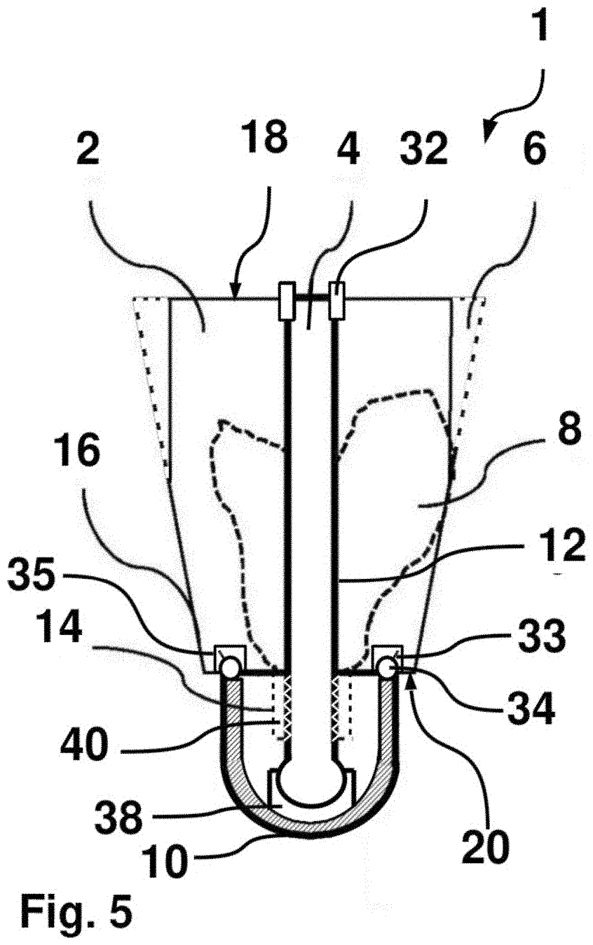

FIG. 5 shows a schematic representation of the lateral cross-section of a further embodiment of a partially manufactured milling blank 1 according to the invention with central pin 4, protective cap 10 with friction fixation 38, schematically indicated implant-supported dental restoration part 8 and an external hex implant connection 14. This embodiment corresponds to a modification of the variant shown in FIG. 4. In this embodiment, an external thread is formed on the truncated cone end or base 20, at the level of the implant connection, on the central pin 4, which is formed to match the thread of the nut of the external hex implant connection 14, so that these two threads can be screwed into each other. This prevents the central pin 4 from being pulled out in the direction of the retaining extension/face 18. In this embodiment example, the protective cap 10 is hollow but thin-walled and is sealed to the base body 2 of the partially finished milling blank by means of a design 34 such that it seals the protective cap against an undercut 33 of the partially finished blank. During the milling process, a sovereign zone 35 is left unmachined around this fixing as a CAD/CAM protective area. This is indicated in FIG. 5 as a rectangle around such a design 34 of the sealing lip. In addition to such a fixing by means of a special design 34 of the sealing lip, the protective cap 10 is fixed to the central pin 4 by means of a friction fixing 38. The central pin 4 penetrates the recess of the protective cap 10, which is preferably made of elastic material, or penetrates it completely and is fixed there by means of frictional locking.

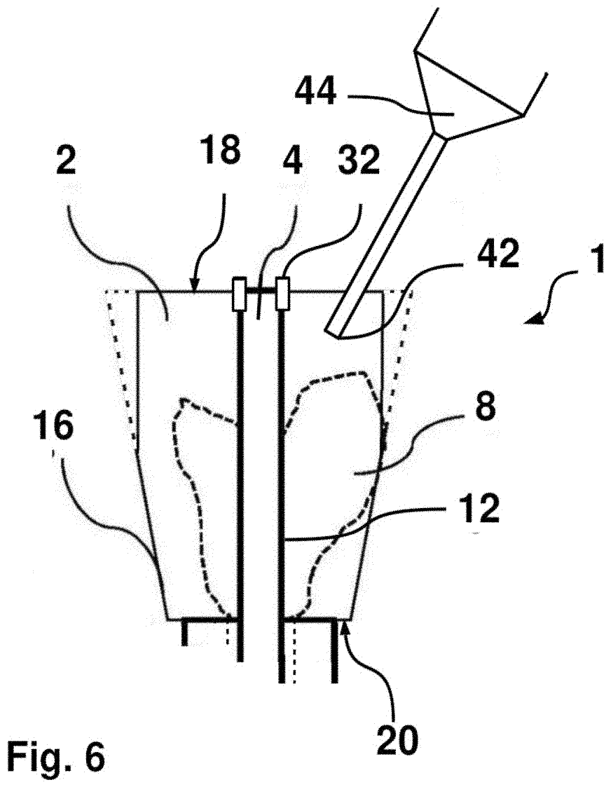

FIG. 6 shows a schematic partial representation of the lateral cross-section of a further embodiment of a partially manufactured milling blank 1 according to the invention with central pin 4, sealing lip 32, schematically indicated implant-supported dental restoration part 8 and a schematic representation of a milling head 44. In this embodiment, a common milling head of a manufacturing device with milling tip 42 is shown schematically. In this illustration, the protective cap and the implant connection are only sketchily indicated at the end of the truncated cone or at the base 20 of the basic body 2 of the partially manufactured milling blank.

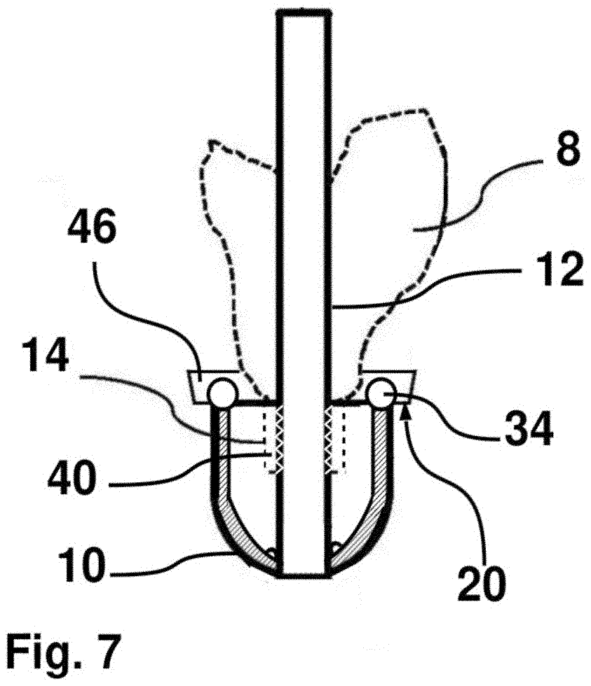

FIG. 7 shows a schematic representation of the lateral cross-section of a further embodiment of a partially manufactured milling blank 1 according to the invention after the milling process with central pin 4, protective cap 10, implant-supported dental restoration part 8 and an external hex implant connection 14. This embodiment corresponds to a machined variant of the embodiment shown in FIG. 5. In this embodiment, the protective cap is sealed to the milled base body 2 of the partially finished milling blank by means of a design 34 such that it seals the protective cap against an undercut 33 of the partially finished milling blank. In order to prevent contamination of the interior of the protective cap by chips, dust or other impurities during the milling process, a so-called sovereign zone 46 is excluded from the milling process. In this embodiment example, this is flat, but a conical design that increases in thickness towards the centre is also conceivable. In addition to sealing the protective cap 10, this also enables it to be securely anchored by means of a special design 34 of the sealing lip. Such a sovereign zone 46 can be, for example, 0.2 mm thick. This zone of highness 46 is removed during finishing, for example by a dental technician using a hand cutter in a dental laboratory.

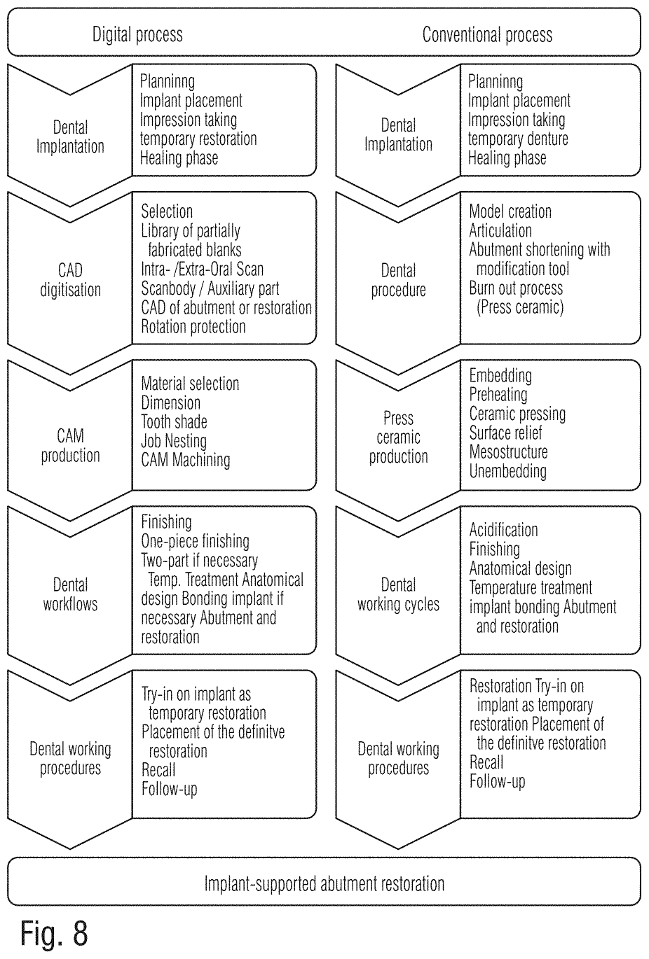

FIG. 8 shows a schematic representation of the manufacturing process of a dental restoration part as a digital process from a partially finished milling blank as a flow chart. For illustration purposes, the conventional process of manufacturing a dental restoration is shown in comparison.

### LIST OF REFERENCE SIGNS

1 Partially manufactured milling blank
2 base body
4 Central pin
5 pin counter element
6 excess areas
8 Implant-supported dental restoration part
10 Protective cap
12 Central canal or canal bore
14 External hex implant connection
16 Truncated cone
18 Face/front end
20 Base or end of truncated cone
22 Recess
24 Retaining element
26 Retaining extension
28 Internal hex implant connection
30 Tapered implant connection
32 Sealing lip
33 Undercut
34 Shaping
35 Highness/Sovereign zone
36 Thread fixation or thread
38 Friction fixation
42 Milling tip
44 Milling head
46 Highness/Sovereign zone

1. A protective cap and milling blank assembly comprising
a milling blank (1) and
a protective cap (10),
wherein the milling blank (1) comprises a retaining element (24) or a retaining extension (26) with which the milling blank (1) is configured for clamping in a clamping holder of a dental milling machine, a central channel (12) which extends over at least 70% of the length of the blank (1) and/or passes therethrough,
wherein the channel (12) ends at or in the retaining element (24) or retaining extension (26),
a central pin (4) which extends in the channel (12), wherein the central pin (4) is either fixed or movably mounted in the channel (12), and
wherein the protective cap (10) covers an end face (20), which lies opposite the retaining element (24) or the retaining extension (26), of the milling blank (1).

2. The protective cap and milling blank assembly according to claim 1,
wherein the milling blank (1) comprises a truncated cone portion extending over more than 30% of the length of the blank at a part of the blank remote from the retaining element (24) or retaining extension (26).

3. The protective cap and milling blank assembly according to claim 1,
wherein the central pin (4) comprises a thread (36) on the end face (20) of the blank (1) which engages with a nut and the protective cap (10) covers the nut.

4. The protective cap and milling blank assembly according to claim 1,
wherein the protective cap (10) is formed from an elastic material and covers an end face (20) on the truncated cone side, of the blank.

5. The protective cap and milling blank assembly according to claim 4,
wherein the elastic material comprises an elastomer and the protective cap covers the end face (20) on the truncated cone side by more than 50%.

6. The protective cap and milling blank assembly according to claim 1,
wherein the protective cap (10) is formed from solid material comprising a plastic and/or metal, and bears at least partially against the central pin (4) and/or an implant connection (14, 28 or 30).

7. The protective cap and milling blank assembly according to claim 1,
wherein a seal is provided between the central pin (4) and the protective cap (10) at the end face (20) and/or between the central pin (4) and the milling blank (1) at the retaining extension side.

8. The protective cap and milling blank assembly according to claim 1,
wherein the central pin (4) is protected from being pulled out by a thickening at one end, a sealing lip or by screws.

9. A milling blank comprising
a retaining element (24) or retaining extension (26), by which the milling blank (1) can be clamped in a clamping holder of a dental milling machine,
a central channel (12) which extends over at least 70% of the length of the blank (1) and/or passes through it, the channel (12) ending at or in the retaining element (24) or retaining extension (26),
a central pin (4) which extends in the channel (12), the central pin (4) being fixed in the channel (12), and
a protective cap (10) covers an end face (20), which is opposite the retaining element (24) or retaining extension (26), of the milling blank (1) and seals the latter, the central pin (4) and thus the opening of the channel (12).

10. The milling blank according to claim 9,
wherein an implant connection (14, 28 or 30) comprising an outer hex (14), an inner hex (28) or a cone (30), is formed on the end face (20) of the blank, which is covered and sealed by the protective cap (10), and
wherein the protective cap (10) is fastened to the central pin (4) by frictional engagement of the sealing ring of the protective cap (10) and of the milling blank (1) and/or by a thread (36).

11. The milling blank according to claim 10,
wherein the central pin (4) has the thread (36) on the end face (20) of the blank which engages with a nut and the protective cap (10) covers the nut.

12. The milling blank according to claim 11,
wherein the central channel (12) has an internal thread at the retaining extension side end and/or at the end face (20) and/or along the entire central channel and the central pin (4) has an external thread matching the thread of the central channel.

13. The milling blank according to claim 12,
wherein a seal is provided between the central pin (4) and the protective cap (10) at the end face (20) and/or between the central pin (4) and the milling blank (1) at the retaining extension side end.

14. A method for producing a milling blank for milling a dental restoration part comprising
providing a blank (1),
creating a central channel (12) in the blank, which ends at or in a retaining element (24) or retaining extension (26), at which the milling blank (1) is configured for clamping in a milling machine,
wherein more than 70% of a length of the blank (1) is partially or fully penetrated with the central channel (12),
introducing a central pin (4) into the central channel (12), the central pin (4) being fixed in the channel (12) at an end having the retaining element or extension, and
wherein the central pin (4) and an end face (20) which is opposite the retaining element (24) or retaining extension (26) are covered, by a protective cap (10) which is attached in a sealing manner to the end face.

15. The method according to claim 14,
wherein the central pin (4) and the end face (20) are covered by the protective cap to at least 50%.

16. The method according to claim 14,
wherein the milling blank (1) is partially manufactured and an implant connection (14, 28 or 30) extends on the end face, which is also covered by the protective cap (10).

17. The method according to claim 14,
wherein the milling blank (1), after being equipped with the central pin (4) and the protective cap (10), is clamped in a clamping holder of a dental milling machine and the dental milling machine mills the milling blank while the central pin (4) extends in the channel (12) and while the protective cap (10) covers part of the end face (20) of the milling blank (1).
